(19) United States
(12) Patent Application Publication
(10) Pub. No.: US 2026/0307462 A1
(43) Pub. Date: Oct. 8, 2026

(54) HEATING SYSTEM FOR HEATING THE PASSENGER COMPARTMENT OF A VEHICLE, IN PARTICULAR OF A MOTOR VEHICLE

(71) Applicant: I.R.C.A. S.P.A. INDUSTRIA RESISTENZE CORAZZATE E AFFINI, Vittorio Veneto (IT)

(72) Inventors: Mauro BERIOLI, Vittorio Veneto (IT); Lorenzo CERASTI, Treviso (IT); Antonio DE MOLINER, Oderzo (IT); Mario EUSEBIO, Pordenone (IT); Ibrahim YANKINE, Montebelluna (IT); Stefano ZANELLA, Montebelluna (IT); Federico ZOPPAS, Treviso (IT)

(21) Appl. No.: 19/484,227

(22) PCT Filed: May 23, 2024
(86) PCT No.: PCT/IB2024/055024

§ 371 Date: Nov. 13, 2025

(30) Foreign Application Priority Data
May 24, 2023 (IT) 102023000010440

(51) Int. Cl. B60H 1/22; G01D 5/24

(52) U.S. Cl. CPC B60H 1/2218; G01D 5/24; B60H 2001/2246

(57) ABSTRACT

A heating system (100) for heating the passenger compartment of a vehicle, in particular of a motor vehicle, comprising
at least one electric heating device (10), adapted to be fixed to, or arranged into a vehicle component;
an electronic control unit (20) connected to said at least one electric heating device (10);
   the heating system (100) being configured to detect whether there is a contact between a user and said at least one electric heating device (10) or between a user and said component;
   wherein the electronic control unit (20) is configured to control the heating of said at least one electric heating device (10) so that
in the absence of said contact, said at least one electric heating device (10) reaches a first temperature (T1);
and when said contact is detected, said at least one electric heating device (10) reaches a second temperature (T2) lower than said first temperature (T1);
wherein said contact is detected when a change in electrical capacitance associated with an electrically conductive track (12) is detected;
and wherein the electronic control unit (20) is configured to compensate for the change in capacitance according to ambient temperature.

### FIELD OF THE INVENTION

The present invention relates to the field of heating systems for vehicles, in particular for motor vehicles.

In particular, the invention relates to a heating system and a related control method.

### BACKGROUND ART

Electric cars have a high-efficiency engine which does not have such a heat dispersion to allow the passenger compartment to heat up as combustion engines. To heat the passenger compartment of an electric car, heat pumps or other heaters are usually used as heating means. However, the heat pump is not very efficient at low temperatures, while the heaters must have high power (around 5 or 6 kW) and consume a lot of energy. In cold periods, such heating means require a high consumption and therefore greatly reduce the autonomy of electric vehicles. Furthermore, the heating is slow since such systems must first heat the air and then heat the passenger compartment. Furthermore, the cold surfaces inside the vehicle absorb heat, thus slowing down the process which leads to a feeling of comfort in the vehicle.

The need is therefore felt for a heating system for heating the passenger compartment of a vehicle, in particular provided with an electric, hybrid or combustion engine, which is particularly effective and efficient.

### SUMMARY OF THE INVENTION

It is an object of the present invention to provide a heating system for heating the passenger compartment of a vehicle, in particular provided with an electric, hybrid or combustion engine, which is particularly effective and efficient.

It is another object of the present invention to provide such a system which allows to quickly obtain a feeling of comfort in the passenger compartment, without the risk of burns.

It is another object of the present invention to provide such a system which can be made at low costs and which can be easily integrated with a component of the passenger compartment of a vehicle.

The present invention achieves at least one of such objects, and other objects which will become apparent in the light of the present description, by means of a heating system for heating the passenger compartment of a vehicle, in particular a motor vehicle, according to claim 1, comprising
at least one electric heating device, adapted to be fixed to, or arranged into a vehicle component;
an electronic control unit connected to said at least one electric heating device; the heating system being configured to detect whether there is a contact between a user and said at least one electric heating device or between a user and said component;
wherein the electronic control unit is configured to control the heating of said at least one electric heating device so that
in absence of said contact, said at least one electric heating device reaches a first temperature;
and when said contact is detected, said at least one electric heating device reaches a second temperature lower than said first temperature;
wherein said at least one electric heating device comprises a support made of electrically insulating material, to which an electrically conductive track is fixed;
wherein said electrically conductive track is electrically connected to said electronic control unit;
wherein said electronic control unit comprises a microcontroller electrically connected to said track, adapted to receive, in particular to read, capacitance values associated with said track; wherein the electronic control unit is configured to detect if there is said contact as a function of said capacitance values;
wherein said contact is detected when a change in electrical capacitance associated with the electrically conductive track is detected;
wherein the electronic control unit is configured to compensate for the change in capacitance according to ambient temperature (i.e., the temperature of the passenger compartment); in particular, wherein the electronic control unit is configured to compensate for the change in capacitance according to ambient temperature read by the microcontroller.

The invention further relates to a vehicle, in particular a motor vehicle, according to claim 13.

The invention also relates to a method for controlling a heating system, according to claim 14, wherein a step of activating the electric heating device is provided for activating the heating thereof, and wherein, following said activation step,
if the electronic control unit detects no contact between a user and said at least one electric heating device, nor between a user and said component, said at least one electric heating device is brought to said first temperature;
if the electronic control unit detects said contact, said at least one electric heating device is brought to said second temperature lower than said first temperature;
wherein said contact is detected when a change in electrical capacitance associated with the electrically conductive track is detected;
and wherein the electronic control unit is configured to compensate for the change in capacitance according to ambient temperature, in particular to compensate for the change in capacitance according to ambient temperature read by the microcontroller, in particular so as to avoid the detection of false contacts due to changes in ambient temperature.

The electrical capacitance varies according to ambient temperature. More in particular, the change in ambient temperature may cause a slow change in capacitance, for example of the order of 10 pF (pico-Farad) or 20 pF in 20 minutes. Instead, the contact, for example with a part of the body, causes a rapid change in capacitance, in particular of the order of 10 pF or 20 pF per second.

Advantageously, the electronic control unit is configured so as to compensate for, i.e., filter, the change in capacitance according to ambient temperature, in particular so as to avoid the detection of false contacts due to the change in electrical capacitance caused by the change in ambient temperature.

In other words, the electronic control unit is configured to perform a low-pass filtering of the read capacitance value, in particular of the digital value of the read capacitance, in particular to compensate for the change in capacitance according to ambient temperature, whereby contact is detected only if the speed of the change in capacitance is greater than a predetermined threshold value.

Therefore, contact detection is much more reliable.

Therefore, the temperature of the electric heating device is prevented from being undesirably reduced.

Advantageously, the heating device may be integrated with a surface inside the passenger compartment and therefore it may generate heat in a localized manner.

Advantageously, moreover, the system allows preventing a user (i.e., a person) from getting burned by touching, for example with a hand, the heating device or the surface of the component onto which the heating device is fixed. In fact, the heating system is configured so that, when the heating is active, so that the heating device is at the first temperature T1, if a contact (or touch) is detected between the user and the component or between the user and the heating device, the heating device is brought to the second temperature T2, lower than the first temperature T1.

Advantageously, thereby, the requirements of the ISO 13732 standard can be met, concerning the heating of the surfaces which may come into contact with people, and defining the maximum temperatures of such surfaces depending on contact time, so as to avoid burns. For example, according to such standard, the maximum contact time for a plastic surface at 60° C. is 1 minute, for a plastic surface at 48° C. is 10 minutes, for a plastic surface at 43° C. is 8 hours or more.

In all embodiments, as already mentioned, said at least one electric heating device comprises a support made of electrically insulating material, onto which an electrically conductive track is fixed and electrically connected to said electronic control unit.

In particular, preferably, said at least one electric heating device is substantially a heating sheet, in particular a flexible heating sheet.

As already mentioned, the heating system is configured to detect the contact by exploiting the electrical capacitance values associated with the conductive track; in particular, the heating system is configured to detect the contact when a change in electrical capacitance associated with the conductive track is detected.

More in particular, the contact may be detected by means of the change in parasitic capacitance between the conductive track and the hand touching the surface. Without ties to any theory, the conductive track and the hand may be diagrammatically shown as the two plates of a capacitor whose change in capacitance is being measured. When the surface is touched, the distance between the two plates of the capacitor is reduced to a minimum, thus determining the change in the parasitic capacitance.

The system is further advantageously configured so as to avoid the detection of false contacts due to changes in electrical capacitance caused by changes in ambient temperature.

Further features and advantages of the invention will become more apparent in light of the detailed description of exemplary but not exclusive embodiments.

The dependent claims describe particular embodiments of the invention.

### BRIEF DESCRIPTION OF THE DRAWINGS

The description of the invention refers to the accompanying drawings, which are provided by way of non-limiting example, in which:

FIG. 1 diagrammatically shows an example of a heating system according to the invention;

FIG. 2 shows examples of components, drawn with fill color, equipped with an electric heating device of a heating system according to the invention.

The same elements or components have the same reference numerals.

### DESCRIPTION OF EXAMPLE EMBODIMENTS OF THE INVENTION

With reference to the Figures, embodiments of a heating system 100 for heating the passenger compartment of a vehicle, in particular of a motor vehicle, are described. Although the heating system is particularly adapted for electric or hybrid motor vehicles, it may also be advantageously used in a combustion motor vehicle.

In all embodiments, the heating system 100 comprises at least one electric heating device, adapted to be fixed onto a vehicle component, or adapted to be arranged into a vehicle component; and an electronic control unit 20 connected to said at least one electric heating device 10; the heating system 100 being configured to detect whether there is a contact (or touch) between a user and said at least one electric heating device 10 or between a user and said component; wherein the electronic control unit 20 is configured to control the heating of said at least one electric heating device 10 so that (in particular, when the electric heating device 10 is activated, i.e., turned on, so as to generate heat), in the absence of said contact, said at least one electric heating device 10 reaches a first temperature T1;

and when said contact is detected, said at least one electric heating device 10 reaches a second temperature T2 lower than said first temperature T1.

For example, said first temperature T 1 is equal to approximately 60° C., for example 60 ±5° C.; and/or said second temperature T2 is less than or equal to approximately 43° C., for example 43±5° C.

The electronic control unit 20 is provided with a power supply block or unit 28. The electronic control unit 20 comprises, for example, an electronic board.

Said at least one electric heating device 10 comprises a support 11 made of electrically insulating material, to which an electrically conductive track 12 is fixed, electrically connected to said electronic control unit 20.

The support 11 is preferably made of plastic. The support 11 is preferably flexible, in particular adapted to be deformed without being damaged.

The electrically conductive track 12 is, in particular, made of metal.

The system 100, in particular, comprises at least one switch 25a, 25b to control the electrical supply of said at least one track 12, in particular to control the heating of the electric heating device 10.

The electric heating device 10 preferably comprises one or more heating elements 13 adapted to generate heat when electrically powered. The electrically conductive track 12 is connected to said one or more heating elements 13 so as to power them electrically. When electrically powered, the one or more heating elements 13 generate heat. In the examples shown, a plurality of heating elements 13 is provided, for example arranged according to a grid. The electrically conductive track 12 preferably comprises a plurality of branches 12b in contact with the heating elements 13. Preferably, the track 12 comprises a peripheral section 12a from which the branches 12b extend.

In particular, the track 12 and the heating elements 13 substantially form a single electrical conductor. Preferably, the function of the track 12 is substantially to electrically power the heating elements 13, and therefore any possible heat generated by the track 12 is substantially negligible.

Optionally, said one or more heating elements 13 have a Positive Temperature Coefficient (PTC) effect.

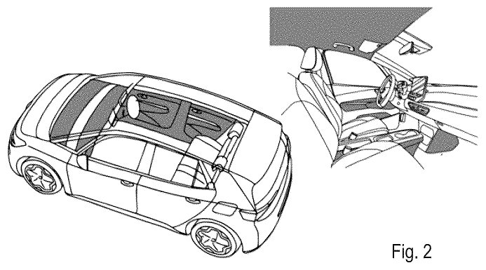

The aforesaid component may be, for example, a seat, a footboard, a mat, a panel, a dashboard, a headliner or a door of a vehicle, or a part thereof. FIG. 2, with fill color, shows, exclusively by way of example and not by way of limitation, some components which may be provided with an electric heating device 10.

The heating system 100 may optionally comprise said component in which said at least one electric heating device 10 is arranged or onto which said at least one electric heating device 10 is fixed.

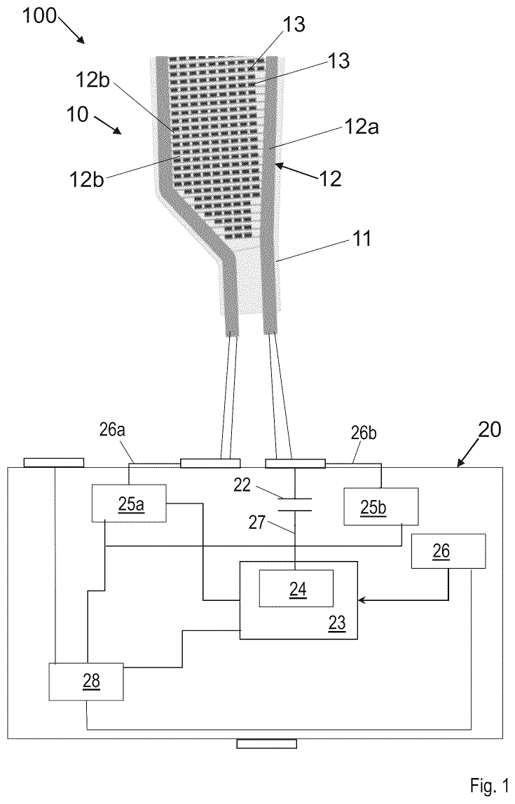

With reference to FIG. 1 the heating system 100 is configured to detect the contact as a function of electrical capacitance values; in particular, the heating system 100 is configured to detect the contact when a change in electrical capacitance is detected.

In particular, the electronic control unit 20 comprises a microcontroller 24 electrically connected to said track 12, adapted to receive, in particular to read, capacitance values associated with said track 12; and the electronic control unit 20, in particular by means of the microcontroller 24, is configured to detect if there is said contact as a function of said capacitance values.

Preferably, the microcontroller is part of a unit 23 capable of reading the electrical capacitance of the track 12.

The microcontroller 24, for example, is provided with a capacitance reading peripheral device.

The microcontroller 24 is connected to the track 12, in particular to an end of the track 12, by means of an electrical connection 27, along which, preferably, there is a capacitor 22. The two ends of the track 12 are connected to the electrical power supply unit 28 by means of a respective electrical connection 26a, 26b, or electrical connection line.

Two switches 25a, 25b are provided, in particular one switch 25a, 25b for each electrical connection 26a, 26b. In particular, one switch 25a, 25b is provided between the power supply unit 28 and the respective end of the track 12.

The microcontroller 24 is electrically connected to the switches 25a, 25b, and is adapted to control, i.e., drive, the switches 25a, 25b as a function of the capacitance values read to control the heating of the electric heating device 10, in particular to control the heating of the heating elements 13.

The electronic control unit 20 is configured to cyclically carry out a capacitance reading by means of the microcontroller 24, in particular when the electric heating device 10 is not active to generate heat. During the reading of the capacitance the switches 25a, 25b are open, leaving the track 12 floating. In other embodiments, the capacitance may also be read during heat generation.

It should be noted that the electrical capacitance varies as a function of the ambient temperature.

More in particular, the change in ambient temperature may cause a slow change in capacitance, for example of the order of 10 pF (pico-Farad) or 20 pF in 20 minutes.

Instead, the contact, for example with a part of the body, causes a rapid change in capacitance, in particular of the order of 10 pF or 20 pF per second.

Advantageously, the electronic control unit 20 is configured so as to compensate for, i.e. filter, the change in capacitance as a function of the ambient temperature, in particular so as to avoid the detection of false contacts due to changes in electrical capacitance caused by a change in the ambient temperature (i.e., the temperature of the passenger compartment), i.e., the electronic control unit is configured to compensate for the change in the capacitance as a function of the ambient temperature read by the microcontroller 24.

Advantageously, in other words, the electronic control unit 20 (in particular the microcontroller 24) is configured to perform a low-pass filtering of the read capacitance value, in particular of the digital value of the read capacitance (in particular to compensate for the change in capacitance as a function of the ambient temperature), whereby contact is detected only if the speed of the change in capacitance is greater than a predetermined threshold value.

Preferably, said predetermined threshold value is from 10 to 20 pF/s; preferably it is equal to about 10 pF/s or 20 pF/s.

Preferably, the electronic control unit 20 is provided with a voltage temperature transduction unit 26 adapted to be connected to one or more temperature sensors, for example thermistors, adapted to detect the ambient temperature, i.e., the temperature of the passenger compartment.

Preferably, the system 100 comprises said one or more temperature sensors.

The microcontroller 24 is adapted to read, preferably using an Analog-to-Digital Converter peripheral (ADC) with which it is preferably provided, values associated with the temperature from the transduction unit 26.

In an example, not shown, of a heating system configured to detect contact as a function of electrical capacitance values, the electric heating device comprises two electrically conductive tracks which are distinct from each other, of which a first track is adapted to generate heat, and a second track is adapted to function as a sensor means, in particular as a capacitive sensor means, for detecting said contact. Said two tracks, in particular, are arranged on the same electrically insulating support.

In another example, not shown, said electrically conductive track is adapted to function both as a heating element (i.e., it may generate heat) and as a capacitive sensor means for detecting said contact.

The invention also relates to a vehicle, in particular a motor vehicle, provided with a heating system 100.

The invention also relates to a method for controlling a heating system 100 wherein a step of activating the electric heating device 10 is provided for activating the heating thereof,
and wherein, following said activation step,
if the electronic control unit 20 detects no contact between a user and said at least one electric heating device 10, nor between a user and said component—or more generally in the absence of said contact—said at least one electric heating device 10 is brought to said first temperature T1;
if the electronic control unit 20 detects said contact—or more generally when said contact is detected-said at least one electric heating device 10 is brought to said second temperature T2 lower than said first temperature T1;
wherein said contact is detected when a change in electrical capacitance associated with the electrically conductive track 12 is detected;
and wherein the electronic control unit 20 is configured to compensate for, i.e., filter, the change in capacitance as a function of the ambient temperature, in particular to avoid the detection of false contacts caused by changes in ambient temperature.

In particular, by means of the electronic control unit 20 a low-pass filtering of the read capacitance value is performed, in particular of the digital value of the read capacitance, in particular to compensate for the change in capacitance as a function of the ambient temperature, whereby contact is detected only if the speed of the change in capacitance is greater than a predetermined threshold value.

Preferably, said predetermined threshold value is from 10 to 20 pF/s; preferably it is equal to about 10 pF/s or 20 pF/s.

1. A heating system for heating the passenger compartment of a vehicle, in particular of a motor vehicle, comprising
at least one electric heating device adapted to be fixed to, or to be arranged into a vehicle component;
an electronic control unit connected to said at least one electric heating device;
the heating system being configured to detect whether there is a contact between a user and said at least one electric heating device or between a user and said component;
wherein the electronic control unit is configured to control the heating of said at least one electric heating device so that
in absence of said contact, said at least one electric heating device reaches a first temperature;
and when said contact is detected, said at least one electric heating device reaches a second temperature lower than said first temperature;
wherein said at least one electric heating device comprises a support made of electrically insulating material, to which an electrically conductive track is fixed;
wherein said electrically conductive track is electrically connected to said electronic control unit;
wherein said electronic control unit comprises a microcontroller electrically connected to said track adapted to receive, in particular to read, capacitance values associated with said track wherein the electronic control unit is configured to detect if there is said contact as a function of said capacitance values;
wherein said contact is detected when a change in electrical capacitance associated with the electrically conductive track is detected;
wherein the electronic control unit is configured to compensate for the change in capacitance according to ambient temperature.

2. A The system according to claim 1, wherein the electronic control unit is configured to perform a low-pass filtering of the read capacitance value, in particular of the digital value of the read capacitance, in particular to compensate for the change in capacitance according to ambient temperature, whereby the contact is detected only if the speed of the change in capacitance is greater than a predetermined threshold value.

3. The system according to claim 2, wherein said predetermined threshold value is from 10 to 20 pF/s; preferably it is equal to about 10 pF/s or it is equal to about 20 pF/s.

4. The system according to claim 1, comprising at least one switch to control the electrical supply of said at least one track.

5. The system according to claim 1, comprising two switches to control the electrical supply of said at least one track;
wherein the microcontroller is electrically connected to the switches and is adapted to control the switches according to the capacitance values read to control the heating of the electric heating device
and wherein the electronic control unit is configured to cyclically perform a capacitance reading by means of the microcontroller.

6. The system according to claim 5, wherein the electronic control unit is configured to open the switches and perform the capacitance reading when the switches are open.

7. The system according to claim 1, wherein said at least one electric heating device comprises one or more heating elements adapted to generate heat when they are electrically powered; wherein said track is connected to said one or more heating elements so as to electrically power them; in particular wherein the track and the heating elements form a single electrical conductor arranged on the support in particular in contact with the same support

8. The system according to claim 7, wherein said one or more heating elements have a Positive Temperature Coefficient (PTC) effect.

9. The system according to any claim 1, wherein said electrically conductive track is adapted to function both as a heating element and as a capacitive sensor means for detecting said contact.

10. The system according to claim 1, comprising a further electrically conductive track adapted to generate heat, in particular adapted to function as a heating element.

11. A The system according to claim 1, wherein said first temperature is equal to 60±5° C.; and/or wherein said second temperature is below or equal to 43±5 °C.

12. A The system according to claim 1, comprising said component into which said at least one electric heating device is arranged or to which said at least one electric heating device is fixed; the component being preferably a seat, a platform, a mat, a panel, a dashboard, a roof or a door of a vehicle.

13. A vehicle, in particular a motor vehicle, provided with a heating system according to claim 1.

14. A method for controlling a heating system according to any claim 1 wherein a step of activating the electric heating device is provided for activating the heating thereof,
and wherein, following said activation step,
if the electronic control unit detects no contact between a user and said at least one electric heating device nor between a user and said component, said at least one electric heating device is brought to said first temperature;
if the electronic control unit detects said contact, said at least one electric heating device is brought to said second temperature lower than said first temperature;
wherein said contact is detected when a change in electrical capacitance associated with the electrically conductive track is detected;
and wherein the electronic control unit is configured to compensate for the change in capacitance according to ambient temperature.

15. The method according to claim 14, wherein by means of the electronic control unit a low-pass filtering of the read capacitance value is performed, in particular of the digital value of the read capacitance, in particular to compensate for the change in capacitance according to ambient temperature, whereby the contact is detected only if the speed of the change in capacitance is greater than a predetermined threshold value.
